(19) United States
(12) Patent Application Publication
(10) Pub. No.: US 2014/0217882 A1
(43) Pub. Date: Aug. 7, 2014

(54) PLASMA GENERATOR AND PLASMA GENERATING DEVICE

(71) Applicant: KYOCERA Corporation, Kyoto (JP)

(72) Inventors: Takashige Yagi, Kyoto-shi (JP); Tetsuya Tojo, Kyoto-shi (JP); Hiroshi Makino, San Diego, CA (US)

(73) Assignee: KYOCERA Corporation, Kyoto-shi, Kyoto (JP)

(21) Appl. No.: 14/241,192

(22) PCT Filed: Aug. 29, 2012
(86) PCT No.: PCT/JP2012/071776

§ 371 Date: Feb. 26, 2014

(30) Foreign Application Priority Data
Aug. 29, 2011 (JP) 2011-186193

(51) Int. Cl. H05H 1/24

(52) U.S. Cl. CPC H05H 1/2406; H05H 2001/2418; H05H 2001/2437; H05H 2001/2462
USPC 313/268

(57) ABSTRACT

A plasma generator has a dielectric with a through hole and has a first electrode and a second electrode provided in the dielectric. The first electrode surrounds the through hole when viewed in the penetrating direction of the through hole. The second electrode includes a downstream region which is positioned further toward one side of the through hole in the penetrating direction of the through hole than the first electrode. When viewed in the penetrating direction of the through hole, the downstream region surrounds the through hole and is further away toward the outer circumferential side from the inner circumferential surface of the through hole than the first electrode.

### FIELD OF INVENTION

The present invention relates to a plasma generator and a plasma generating device.

### BACKGROUND

Plasma generators have been utilized for reforming harmful gases and other gases, processing semiconductor wafers etc., light sources, and various other applications.

Patent Literature 1 discloses a plasma generator which has a dielectric in which a through hole is formed and a pair of electrodes which are buried in the dielectric and face each other across the through hole. In the plasma generator, plasma is generated by application of voltage across the pair of electrodes.

Further, Patent Literature 2 discloses an ion wind generator (plasma generator) which has a flat plate-shaped dielectric and a pair of electrodes which are provided on a major surface of the dielectric. In this ion wind generator, plasma is generated on the major surface of the dielectric by application of voltage across the pair of electrodes and, in turn, an ion wind is generated which flows along the major surface.

Note that, the plasma generator of Patent Literature 1 does not have the function of generating an ion wind in the through hole because the pair of electrodes face each other across the through hole.

### CITATIONS LIST

### Patent Literature

Patent Literature 1: Japanese Patent Publication No. 2008-117532A
Patent Literature 2: Japanese Patent Publication No. 2008-290711A

### SUMMARY

### Technical Problem

As an example of the applications of plasma, attention will be paid to reforming a gas by plasma.

In this case, in the plasma generator in Patent Literature 1, it may be considered to make the through hole narrower so as to increase the collision of the gas and plasma and improve the efficiency of plasma treatment. However, if making the through hole narrower, the pressure loss will become greater and conversely the efficiency of plasma treatment is liable to fall.

Further, the ion wind generator of Patent Literature 2, as explained above, is not aimed at treatment of a gas by plasma. Even if a gas were supplied to the surroundings of the dielectric, only the gas in the vicinity of the major surface of the dielectric could be reformed. Therefore, this cannot be utilized for reforming a gas.

In this way, the plasma generator of Patent Literature 1 or 2 is not suitable for efficient reforming of a gas. Note that while attention was paid to reforming a gas, for other applications as well, the art of Patent Literature 1 or 2 does not necessarily produce a structure which is capable of efficiently generating and utilizing plasma. Provision of a new structure of a plasma generator is desired.

### Solution to Problem

A plasma generator according to an aspect of the present invention has a dielectric with a through hole; a first electrode which is provided in the dielectric and surrounds the through hole when viewed in the penetrating direction of the through hole; and a second electrode which is provided in the dielectric and includes a downstream region which is positioned further toward one side of the penetrating direction than the first electrode, the downstream region surrounding the through hole and being further away from the inner circumferential surface of the through hole toward the outer circumferential side than the first electrode when viewed in the penetrating direction.

A plasma generating device according to an aspect of the present invention has a dielectric with a through hole; a first electrode which is provided in the dielectric and surrounds the through hole when viewed in the penetrating direction of the through hole; a second electrode which is provided in the dielectric and includes a downstream region positioned further toward one side of the penetrating direction than the first electrode, the downstream region surrounding the through hole and being further away from the inner circumferential surface of the through hole toward the outer circumferential side than the first electrode when viewed in the penetrating direction; and a power source for applying voltage across the first electrode and the second electrode.

### Advantageous Effects of Invention

According to the above configurations, efficient generation/utilization of plasma can be expected. As an example, plasma treatment of a gas can be efficiently carried out.

### BRIEF DESCRIPTION OF THE DRAWINGS

FIG. 1A is a perspective schematic view which shows an appearance of a plasma generator according to a first embodiment of the present invention, while FIG. 1B is a cross-sectional schematic view along a line Ib-Ib in FIG. 1A.

FIG. 2 A disassembled perspective view of the plasma generator of FIG. 1.

FIG. 3 An enlarged view of a region III of FIG. 1.

FIG. 4 A cross-sectional view which shows a plasma generator according to a second embodiment of the present invention.

FIG. 5A is a cross-sectional view which shows a plasma generator according to a third embodiment, while FIG. 5B is a cross-sectional view along a line Vb-Vb of FIG. 5A.

FIG. 6 A cross-sectional view which shows a plasma generator according to a fourth embodiment of the present invention.

FIG. 7 A cross-sectional view which shows a plasma generator according to a fifth embodiment of the present invention.

### DETAILED DESCRIPTION OF THE PREFERRED EMBODIMENTS

Below, plasma generators and plasma generating devices according to a plurality of embodiments of the present invention will be explained with reference to the drawings. Note that, the drawings used in the following explanation are schematic ones, and dimensions, ratios, etc. on the drawings do not always coincide with the real ones.

The configurations the same or similar to each other will be sometimes expressed by adding capital letters of the alphabet to the notations, for example, as in the “insulation layer 7A” and “insulation layer 7B”. Further, sometimes the capital letters of the alphabet will be omitted and the configurations will be simply referred to as the “insulation layers 7” without distinguishing between them.

In the second and following embodiments, for configurations which are common with or similar to those of the already explained embodiments, sometimes notations common to those in the already explained embodiments will be used, and illustrations and explanations will be omitted.

### First Embodiment

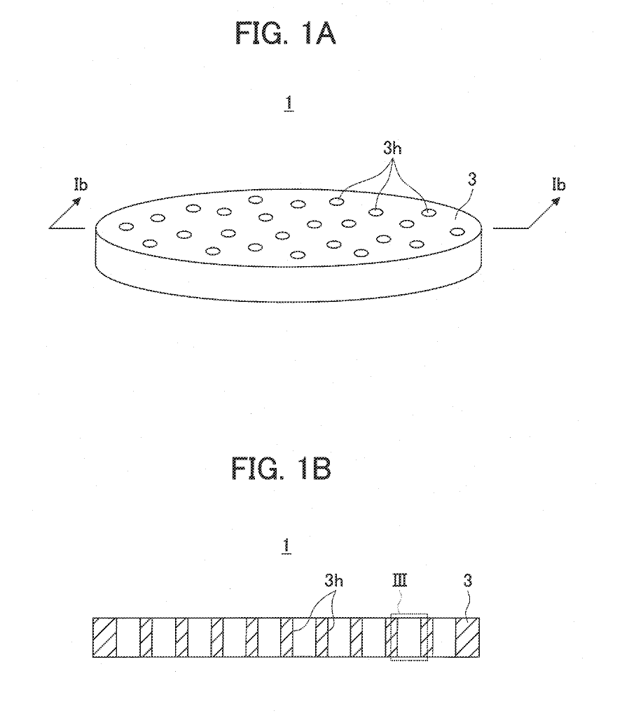

FIG. 1A is a perspective schematic view which shows an appearance of a plasma generator 1 according to a first embodiment of the present invention, and FIG. 1B is a schematic cross-sectional view taken along a line Ib-Ib in FIG. 1A.

The plasma generator 1 has a dielectric 3 which is formed in roughly a flat plate-state. In the dielectric 3, a plurality of through holes 3h which pass through the thickness direction thereof are formed. The planar shapes of the dielectric 3 and through holes 3h may be suitably set. In FIG. 1, however, a case of circles is exemplified. The plurality of through holes 3h are for example formed so that they have the same shapes and sizes as each other and are roughly equally distributed in the dielectric 3.

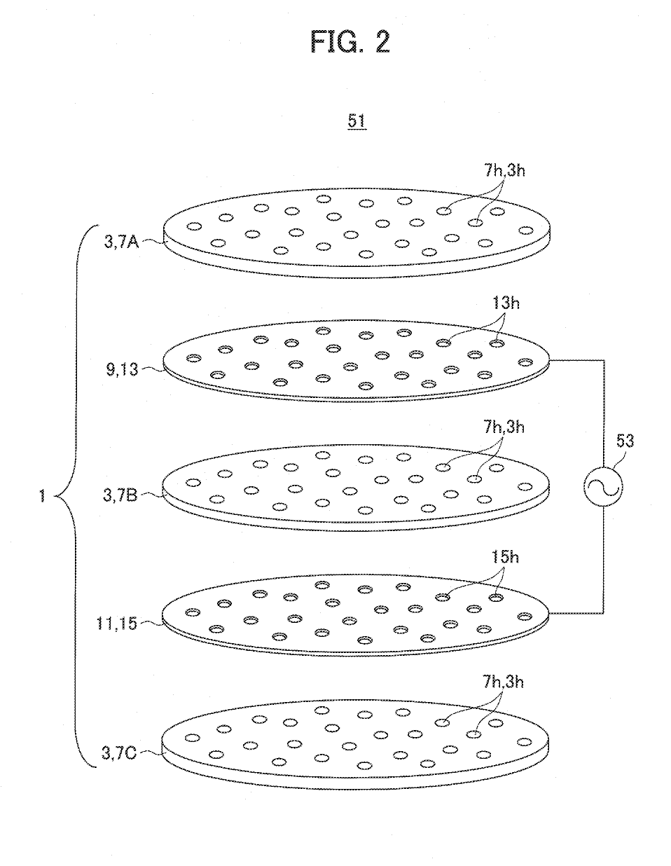

FIG. 2 is a disassembled perspective view of the plasma generator 1.

The plasma generator 1 has a plurality of insulation layers 7 which configure the dielectric 3 and a first electrode 9 and a second electrode 11 which are arranged among the insulation layers 7. Note that, the plasma generator 1, other than these, has interconnects for connecting the first electrode 9 or second electrode 11 to the outside of the dielectric 3, or the like, but the illustration is omitted. Further, in the following description, the first electrode 9 and the second electrode 11 will be sometimes referred to as a first layer-shaped part 13 and a second layer-shaped part 15.

A plasma generating device 51 is configured by including the plasma generator 1 and a power source 53 for applying a voltage to the first electrode 9 and second electrode 11. Note that, the plasma generating device 51, other than these, may have a control device for controlling the power source 53, or the like.

Each insulation layer 7 is for example formed in a flat plate shape (board shape) with a constant thickness. The contours (outer edges) thereof have for example roughly the same shapes and sizes as each other among the insulation layers 7. Further, the plurality of insulation layers 7 are stacked to form the dielectric 3. The number of the plurality of insulation layers 7 and the thickness of each insulation layer 7 may be suitably set in accordance with the positions of arrangement of the first electrode 9 and second electrode 11 and so on.

In each insulation layer 7, a plurality of through holes 7h are formed. By stacking of the plurality of insulation layers 7 and superimposition of the plurality of through holes 7h, the through holes 3h of the dielectric 3 are configured.

The insulation layers 7 may be formed by an inorganic insulating material or may be formed by an organic insulating material. As the inorganic insulating material, for example, ceramic and glass can be mentioned. As the ceramic, for example, an aluminum oxide sintered body (alumina ceramic), glass ceramic sintered body (glass ceramic), mullite sintered body, aluminum nitride sintered body, cordierite sintered body, and silicon carbide sintered body can be mentioned. As the organic insulating material, for example polyimide, epoxy, and rubber can be mentioned. The plurality of insulation layers 7 are basically formed by materials the same as each other, but may be formed by materials different from each other as well.

Each of the first electrode 9 and the second electrode 11 is formed in for example a flat plate shape (layer shape) with a constant thickness. The contour (outer edge) thereof is for example made one roughly similar to the contour of the insulation layers 7. Further, it is formed a bit smaller than the contour of the insulation layers 7. The first electrode 9 and second electrode 11 are buried in the dielectric 3 due to their arrangement among the plurality of insulation layers 7. Further, the first electrode 9 and second electrode 11 are isolated from each other by the insulation layers 7 (dielectric 3) while facing each other in the penetrating direction of the through holes 3h.

In the first electrode 9, a plurality of first openings 13h are formed at positions which correspond to the plurality of through holes 3h. The plurality of first openings 13h are for example formed in the same shapes and sizes as each other. In the same way, in the second electrode 11, a plurality of second openings 15h are formed at positions which correspond to the plurality of through holes 3h. The plurality of second openings 15h are for example formed in the same shapes and sizes as each other. By formation of the first openings 13h and second openings 15h, the through holes 3h penetrate through the dielectric 3 without being obstructed by the first electrode 9 and second electrode 11.

The first electrode 9 and second electrode 11 are formed by conductive material such as metal. As the metal, there can be mentioned for example tungsten, molybdenum, manganese, copper, silver, gold, palladium, platinum, nickel, cobalt, or an alloy containing these as principal ingredients.

The power source 53 applies an AC voltage to the first electrode 9 and second electrode 11. The AC voltage which is applied by the power source 53 may be a voltage which is represented by a sine wave etc. and continuously changes in the potential or may be a voltage which is a pulse state and discontinuously changes in potential. Further, the AC voltage may be a voltage which fluctuates in potential relative to the reference potential at both of the first electrode 9 and second electrode 11 or may be a voltage which fluctuates in potential relative to the reference potential only on one side of the first electrode 9 and second electrode 11 since the other side is connected to the reference potential. The fluctuation of the potential may be fluctuation to both of positive and negative sides relative to the reference potential or may be fluctuation to only one of the positive or negative sides relative to the reference potential.

Note that, dimensions of the dielectric 3, first electrode 9, and the second electrode 11 and the magnitude and frequency of the AC voltage may be suitably set in accordance with the technical field to which the plasma generating device 51 (plasma generator 1) is applied, the required quantity of plasma, and other various matters. Note that, as an example, the diameter of the through holes 3h is 1 to 2 mm.

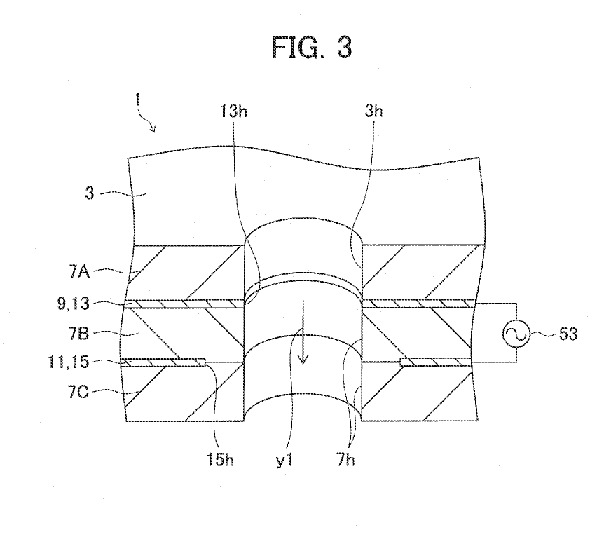

FIG. 3 is an enlarged view of a region III in FIG. 1B. Note, the depth is also shown in order to facilitate understanding.

The through holes 7h of the insulation layer 7A, insulation layer 7B, and insulation layer 7C are formed in the same shapes and sizes as each other. Accordingly, the through holes 3h in the dielectric 3 are constant in diameter in their penetrating direction.

Further, the first openings 13h of the first electrode 9 are formed in the same shapes and sizes as the through holes 3h. Accordingly, the first electrode 9 is exposed in the through holes 3h at the edge parts of the first openings 13h.

On the other hand, the second openings 15h of the second electrode 11 are formed larger than the through holes 3h and first openings 13h. Accordingly, the edge parts of the second openings 15h are buried in the dielectric 3 and are furthermore away from the inner circumferential surfaces of the through holes 3h than the edge parts of the first openings 13h. In more detail, the edge parts of the second openings 15h are further away to the outer circumferential sides from the inner circumferential surfaces of the through holes 3h.

When taking as an example a case where the dielectric 3 is configured by a ceramic sintered body, the method of production of the plasma generator 1 is as follows.

First, ceramic green sheets which form the insulation layers 7 are prepared. A ceramic green sheet is formed by for example forming a slurry into a sheet shape by the doctor blade method, calendar roll method, or the like. The slurry is prepared by adding a suitable organic flux and solvent to a powder of the starting material and mixing. The powder of the starting material, when taking as an example an alumina ceramic, is comprised of alumina (Al2O3), silica (SiO2), calcia (CaO), magnesia (MgO), etc.

Next, in the ceramic green sheets, the through holes 7h are formed by punching or laser machining or the like. Further, a conductive paste which becomes the first electrode 9 and second electrode 11 is provided on the ceramic green sheets. Specifically, a conductive paste which becomes the first electrode 9 is provided on the surface of the ceramic green sheet which forms the insulation layer 7A on the insulation layer 7B side or on the surface of the ceramic green sheet which forms the insulation layer 7B on the insulation layer 7A side. Further, a conductive paste which becomes the second electrode 11 is provided on the surface of the ceramic green sheet which becomes the insulation layer 7B on the insulation layer 7C side or on the surface of the ceramic green sheet which becomes the insulation layer 7C on the insulation layer 7B side.

The conductive paste is prepared by for example adding an organic solvent and organic binder to powder of metal such as tungsten, molybdenum, copper or silver and mixing. To the conductive paste, a dispersant, plasticizer, or the like may be added according to need as well. The mixing is carried out by for example kneading means such as a ball mill, triple roll mill or planetary mixer. Further, the conductive paste is printed and coated on the ceramic green sheet by for example using printing means such as a screen printing method.

Further, the plurality of ceramic green sheets which form the insulation layer 7A to insulation layer 7C are stacked, and the conductive paste and ceramic green sheets are simultaneously fired. Due to this, a dielectric 3 in which the first electrode 9 and second electrode 11 are buried and the through holes 3h are formed, that is, the plasma generator 1, is formed.

In the following description, the mode of operation of the plasma generator 1 will be explained.

The plasma generator 1 is used in a state where the gas to be treated (or air etc. before introduction of the gas) is filled in the through holes 3h. Note that, the gas to be treated is for example nitrogen oxide (NOx), Freon, CO2, volatile organic compounds (VOC), or air which contains these. The exhaust gas of automobiles is well known as gas which contains nitrogen oxide (NOx).

When voltage is applied to the first electrode 9 and second electrode 11, electric fields are formed in the through holes 3h of the dielectric 3. Further, when the intensity of the electric fields in the through holes 3h exceeds a predetermined discharge start field intensity, a dielectric barrier discharge is started and plasma is generated.

The generated plasma can promote a chemical reaction of the gas to be treated and reform the gas by contact with the gas.

Further, electrons and ions in the plasma move due to the electric fields formed by the first electrode 9 and second electrode 11. Further, neutral molecules move following the electrons and ions as well. Due to this, an ion wind flowing in the penetrating direction of the through holes 3h is induced in the through holes 3h. More specifically, since the first electrode 9 is exposed and the second electrode 11 is buried in the dielectric, a dielectric barrier discharge is generated from the first electrode 9 to second electrode 11 side, and an ion wind which flows from the first electrode 9 side to the second electrode 11 side is generated as indicated by an arrow y1.

As described above, in the present embodiment, the plasma generator 1 has the dielectric 3 which has the through holes 3h formed therein and has the first electrode 9 and the second electrode 11 provided in the dielectric 3. The first electrode 9 surrounds the through holes 3h when viewed in the penetrating direction of the through holes 3h. The second electrode 11 includes a downstream region (the whole second electrode 11 in the present embodiment) which is positioned further toward one side of the through holes in the penetrating direction of the through holes 3h than the first electrode 9. When viewed in the penetrating direction of the through holes 3h, the downstream region surrounds the through holes 3h and is further away toward the outer circumferential sides from the inner circumferential surfaces of the through holes 3h than the first electrode 9.

Accordingly, plasma is generated over the entire circumferences of the through holes 3h by the first electrode 9 and second electrode 11 which surround the through holes 3h, and that plasma is restricted in diffusion to the diametrical direction of the through holes 3h by the inner circumferential surfaces of the through holes 3h, so contact of the gas which is supplied to the through holes 3h with respect to the plasma is increased and plasma treatment of the gas can be efficiently carried out. In order to increase contact between the gas and the plasma, preferably the diameter of the through holes 3h is made small. Note, in this case, the pressure loss when the gas flows in the through holes 3h becomes large. In the plasma generator 1, however, the pressure loss can be compensated for by the ion wind, therefore the diameter of the through holes 3h can be made smaller and more efficient plasma treatment can be carried. Further, the configuration for treating the gas and the configuration for inducing the ion wind are used in common, therefore the number of members etc. does not increase.

The downstream region (in the present embodiment, the second electrode 11 as a whole) includes the second layer-shaped part 15 (in the present embodiment, the second electrode 11 as a whole) which is formed in a shape of a flat plate which faces the penetrating direction of the through holes 3h and has second openings 15h formed at positions which correspond to the through holes 3h.

Accordingly, for example, the dielectric 3 and second layer-shaped part 15 can be given the same configuration as that of a multilayer board, therefore production facilities for multilayer boards can be utilized and know-how concerned with materials or the production method etc. for multilayer boards can be utilized. As a result, costs can be kept down while a preferred plasma generator 1 is prepared.

In the same way, the first electrode 9 includes the first layer-shaped part 13 (in the present embodiment, the first electrode 9 as a whole) which is formed in a shape of a flat plate which faces the penetrating direction of the through holes 3h and has first openings 13h formed at positions which correspond to the through holes 3h, therefore costs can be kept down while a preferred plasma generator 1 is prepared.

### Second Embodiment

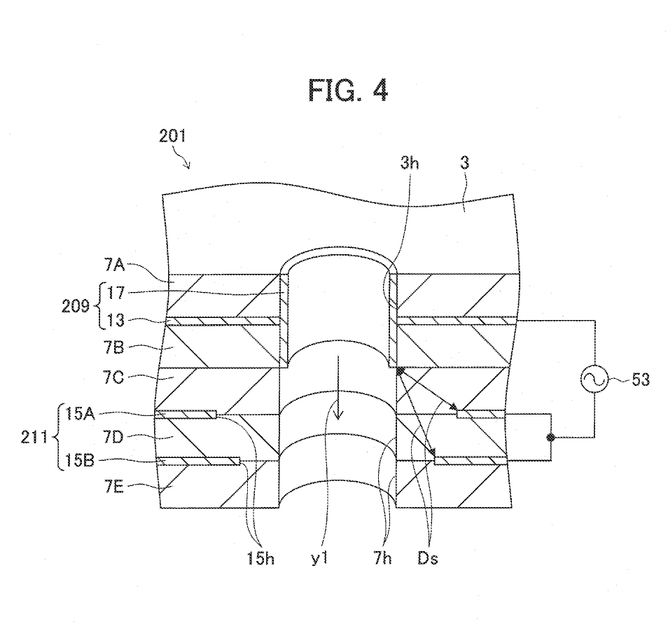

FIG. 4 is a cross-sectional view which shows a plasma generator 201 according to a second embodiment and corresponds to FIG. 3.

Note that, in the following embodiments, for the dielectrics, use will be made of the notation of the “dielectric 3” in the same way as the first embodiment even when the thicknesses and numbers etc. of the insulation layers 7 change in accordance with the configurations of the first electrodes and second electrodes. Further, the notations “A”, “B”, etc. of the insulation layers 7 are for differentiating the insulation layers 7 from each other in each embodiment and do not mean common configurations among the plurality of embodiments.

A first electrode 209 in the plasma generator 201 has a first layer-shaped part 13 in the same way as the first embodiment and tubular parts 17 which are provided on the inner circumferential surfaces of the through holes 3h.

The tubular parts 17 are tubular shape which are configured by conductive layers with generally constant thicknesses which are provided over the entire circumferences of the through holes 3h. The tubular parts 17 are connected at their outer circumferential surfaces to the first layer-shaped part 13 and are connected through the first layer-shaped part 13 to a power source 53. Further, the tubular parts 17 are for example formed by the same material as the first layer-shaped part 13.

The tubular parts 17 are for example formed by a conductive paste being coated on the inner circumferential surfaces of the through holes 7h in the stacked ceramic green sheets which form the insulation layer 7A and insulation layer 7B and by this conductive paste being simultaneously fired with the ceramic green sheets.

Further, the second electrode 211 in the plasma generator 201 includes two or more second layer-shaped parts 15 similar to the first embodiment. The two or more second layer-shaped parts 15 are arranged in the penetrating direction of the through holes 3h and face each other across the insulation layer 7.

Among the plurality of second layer-shaped parts 15, the diameters of the second openings 15h become relatively smaller the further away from the first electrode 209 in the penetrating direction of the through holes 3h. In other words, the further away the plurality of second layer-shaped parts 15 from the first electrode 209 in the penetrating direction of the through holes 3h, the closer to the inner circumferential surfaces of the through holes 3h. Accordingly the difference between distances Ds (shortest distances) between the plurality of second layer-shaped parts 15 and the first electrode 209 is reduced compared with a case where the diameters of the plurality of second openings 15h are made the same as each other. Preferably, the distances Ds between the plurality of second layer-shaped parts 15 and the first electrode 209 are the same as each other.

Further, the plurality of second layer-shaped parts 15 are for example connected in series or parallel to the power source 53 by not shown via conductors formed in the dielectric 3 and/or not shown interconnects outside the dielectric 3. Note that, FIG. 4 exemplifies a case where they are connected in parallel.

In the above second embodiment, the plasma generator 201 has the dielectric 3 which has the through holes 3h formed therein and has the first electrode 209 and second electrode 211 formed in the dielectric 3. The first electrode 209 surrounds the through holes 3h when viewed in the penetrating direction of the through holes 3h. The second electrode 211 includes a downstream region (in the present embodiment, the second electrode 211 as a whole) which is positioned further toward one side in the penetrating direction of the through holes 3h than the first electrode 209. When viewed in the penetrating direction of the through holes 3h, the downstream region surrounds the through holes 3h and is further away toward the outer circumferential sides from the inner circumferential surfaces of the through holes 3h than the first electrode 209.

Accordingly, the same advantageous effects as those by the first embodiment are exhibited. That is, inside the through holes 3h, the gas is evenly brought into contact with the plasma, and the pressure loss is compensated for by the ion wind, therefore plasma treatment of the gas can be efficiently carried out.

Further, in the plasma generator 201, the downstream region (in the present embodiment, the second electrode 211 as a whole) includes a plurality of second layer-shaped parts 15 (in the present embodiment, the second electrode 211 as a whole) which are arranged in the penetrating direction of the through holes 3h.

Here, the longer the length of the downstream region in the flow direction of the ion wind, the larger the volume and/or velocity of the ion wind. Accordingly, due to the arrangement of the plurality of second layer-shaped parts 15, the volume and/or velocity of the ion wind becomes larger, therefore the plasma treatment can be carried out more efficiently and/or faster.

Further, in the plasma generator 201, the downstream region (in the present embodiment, the second electrode 211 as a whole) has a first portion (second layer-shaped part 15A) and a second portion (second layer-shaped part 15B) which is positioned more on the downstream side in the penetrating direction of the through holes 3h than the first portion and is closer to the inner circumferential surfaces of the through holes 3h than the first portion.

Here, in regions of the inner circumferential surfaces of the through holes 3h which overlap with the second electrode 211, the volume and/or velocity of the ion wind which is generated is larger at the position the shorter the distance Ds between the first electrode 209 (its downstream side edge portion) and the second electrode 211. On the other hand, if the distance Ds is too short, insulation breakdown occurs in the dielectric 3. Accordingly, the second layer-shaped part 15B at the downstream side is closer to the through holes 3h and the fluctuation in the distance Ds among the plurality of second layer-shaped parts 15 is suppressed, so insulation breakdown in the dielectric 3 can be suppressed while the volume and/or velocity as the ion wind as a whole can be made larger.

Further, in the plasma generator 201, the first electrode 209 includes tubular parts 17 which are provided on the inner circumferential surfaces of the through holes 3h and surround the through holes 3h.

Accordingly, the first electrode 209 can be reliably exposed in the through holes 3h. That is, if the first electrode included only the first layer-shaped part 13, part of the edge parts of the first layer-shaped part 13 would be covered by the dielectric 3 due to manufacturing error etc., therefore suitable discharge would be liable to not occur. However, such an inconvenience does not occur in the plasma generator 201.

### Third Embodiment

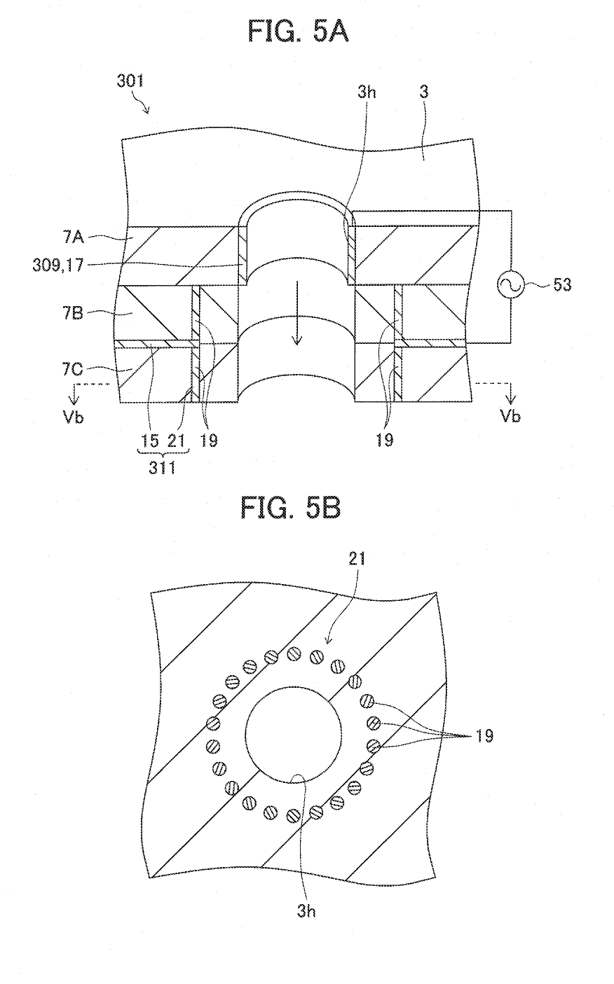

FIG. 5A is a cross-sectional view which shows a plasma generator 301 according to a third embodiment and corresponds to FIG. 3. FIG. 5B is a cross-sectional view taken along a line Vb-Vb in FIG. 5A.

A first electrode 309 in the plasma generator 301 is configured by tubular parts 17 similar to the second embodiment. In other words, the first electrode 309 does not have the first layer-shaped part 13. The first electrode 309 is for example connected to the power source 53 through not shown interconnects formed on the major surface or inside of the dielectric 3 and/or not shown interconnects outside of the dielectric 3.

Further, a second electrode 311 in the plasma generator 301 has the second layer-shaped part 15 similar to the first embodiment and a plurality of via conductors 19 which penetrate through the insulation layers 7 (at least a portion of the dielectric 3).

The via conductors 19 may be provided in a suitable number of the insulation layers 7 among the plurality of insulation layers 7. In FIG. 5, they are provided in the insulation layers 7B and 7C. Further, the via conductors 19 are arranged so as to surround the through holes 3h and thereby form ring-shaped portions 21. Note that, the ring-shaped portions 21 may be defined for each insulation layer 7 or may be defined for the entire plurality of insulation layers 7 which have the via conductors 19 formed therein.

In the via conductors 19, the end parts which are exposed at the major surfaces of the insulation layers 7 are connected to the second layer-shaped part 15 and are connected through the second layer-shaped part 15 to the power source 53. Note that, the via conductors 19 may be connected to the power source 53 through not shown interconnects which are formed on the major surface of the dielectric 3 and/or not shown interconnects outside of the dielectric 3.

The via conductors 19 are formed by for example vias being formed by punching or laser machining or the like in the ceramic green sheets which form the insulation layer 7B and insulation layer 7C, conductive paste being filled in the vias, and the ceramic green sheets and conductive paste being simultaneously fired.

In the above third embodiment, the plasma generator 301 has the dielectric 3 which has the through holes 3h formed therein and the first electrode 309 and the second electrode 311 which are provided in the dielectric 3. The first electrode 309 surrounds the through holes 3h when viewed in the penetrating direction of the through holes 3h. The second electrode 311 includes a downstream region (in the present embodiment, the second electrode 311 as a whole) which is positioned further toward one side in the penetrating direction of the through holes 3h than the first electrode 309. When viewed in the penetrating direction of the through holes 3h, the downstream region surrounds the through holes 3h and is further away toward the outer circumferential sides from the inner circumferential surfaces of the through holes 3h than the first electrode 309.

Accordingly, the same advantageous effects as those by the first embodiment are exhibited. That is, inside the through holes 3h, the gas is evenly brought into contact with the plasma, and the pressure loss is compensated for by the ion wind, therefore plasma treatment of the gas can be efficiently carried out.

Further, in the plasma generator 201, the downstream region (second electrode 311) includes the ring-shaped portions 21 which extend in the penetrating direction of the through holes 3h and surround the through holes 3h.

Accordingly, in the same way as the second embodiment, by making the second electrode 311 larger in the penetrating direction of the through holes 3h, the volume and/or velocity of the ion wind can be made larger. Note that, here, extension in the penetrating direction means that the length of the conductor in the penetrating direction of the through holes 3h is larger than the thickness of the conductor in the radiating direction (radial direction) from the through holes 3h.

Further, in the plasma generator 301, the ring-shaped portions 21 are configured by pluralities of via conductors 19 which penetrate through at least a portion of the dielectric 3 in the penetrating direction being arranged so as to surround the through holes 3h.

Accordingly, in the same way as the second layer-shaped part 15, the ring-shaped portions 21 can be configured by utilizing the production facilities and know-how of multilayer boards, therefore costs can be kept down while a preferred plasma generator 1 is prepared.

### Fourth Embodiment

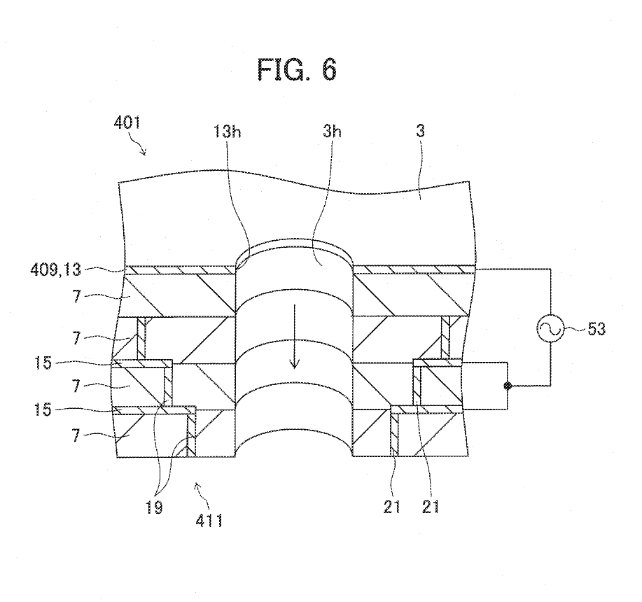

FIG. 6 is a cross-sectional view which shows a plasma generator 401 according to a fourth embodiment and corresponds to FIG. 3.

A first electrode 409 in the plasma generator 401 is configured by a first layer-shaped part 13 which is formed on the major surface of the dielectric 3. The first electrode 409 is for example connected to the power source 53 through not shown interconnects formed on the major surface or inside of the dielectric 3 and/or not shown interconnects outside of the dielectric 3.

Further, in the same way as the third embodiment (FIG. 5), a second electrode 411 in the plasma generator 401 has the second layer-shaped part 15 and via conductors 19. Note, these are provided in pluralities of sets and are configured so that, in the same way as the second embodiment (FIG. 4), the further away from the first electrode 409 in the penetrating direction of the through holes 3h, the closer to the inner circumferential surfaces of the through holes 3h.

In the above fourth embodiment, the plasma generator 401 has the dielectric 3 which has the through holes 3h formed therein and the first electrode 409 and second electrode 411 which are provided at the dielectric 3. The first electrode 409 surrounds the through holes 3h when viewed in the penetrating direction of the through holes 3h. The second electrode 411 includes a downstream region (in the present embodiment, the second electrode 411 as a whole) which is positioned further toward one side in the penetrating direction of the through holes 3h than the first electrode 409. When viewed in the penetrating direction of the through holes 3h, the downstream region surrounds the through holes 3h and is further away toward the outer circumferential sides from the inner circumferential surfaces of the through holes 3h than the first electrode 409.

Accordingly, the same advantageous effects as those by the first embodiment are exhibited. That is, inside the through holes 3h, the gas is evenly brought into contact with the plasma, and the pressure loss is compensated for by the ion wind, therefore plasma treatment of the gas can be efficiently carried out. Further, by providing the characteristic features of the second and third embodiments, the volume and/or velocity of the ion wind can be made larger.

### Fifth Embodiment

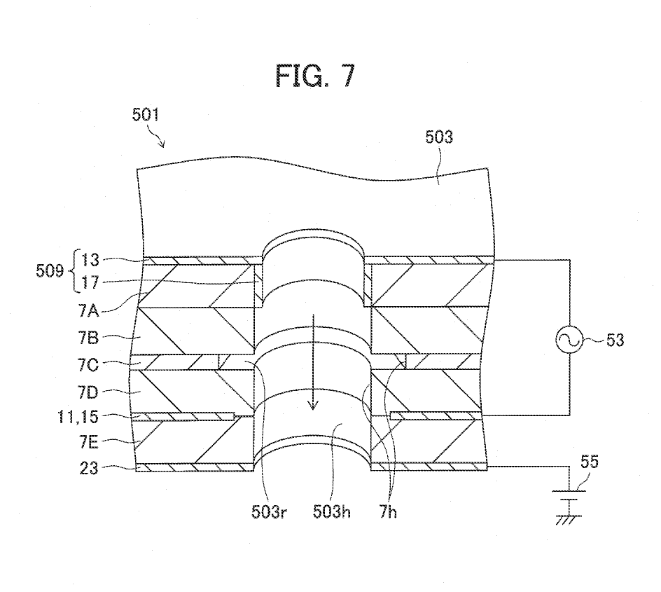

FIG. 7 is a cross-sectional view which shows a plasma generator 501 according to a fifth embodiment and corresponds to FIG. 3.

A first electrode 509 in the plasma generator 501 is a combination of the first electrode 309 in the third embodiment (FIG. 5) and the first electrode 409 in the fourth embodiment (FIG. 6).

Further, the plasma generator 501 has a DC electrode 23 to which a direct current is applied at the further downstream side than the second electrode 11. The DC electrode 23 is for example configured by a layer-shaped part which is formed on the major surface of the dielectric 503. Note that, the DC electrode 23 may be configured by including, in place of or addition to the layer-shaped part, conductive layers which are formed on the inner circumferential surfaces of the through holes 3h in the same way as the tubular parts 17 and/or the same layer-shaped part as the second layer-shaped part 15 which is buried in the dielectric 3.

The DC electrode 23 is connected to a DC power source 55 through not shown interconnects formed inside, on the major surface, or outside of the dielectric 3. The DC power source 55 applies DC voltage to the DC electrode 23 in a state without formation of a closed loop. That is, to the DC electrode 23, only a positive terminal or a negative terminal of the DC power source 55 is connected, therefore a closed loop in which the current from the DC power source 55 flows is not configured.

When a DC voltage is applied to the DC electrode 23 by the DC power source 55, an electric field is formed around the DC electrode 23. In other words, an electric field is formed in the downstream area of the ion wind induced by the first electrode 9 and second electrode 11.

Accordingly, by pulling electrons or ions which are contained in the ion wind to the DC electrode 23 side, the ion wind can be accelerated. For example, when a positive potential is given to the DC electrode 23, negative electric charges are pulled to the DC electrode 23, therefore the ion wind can be accelerated. When a negative potential is given to the DC electrode 23, positive electric charges are pulled to the DC electrode 23, therefore the ion wind can be accelerated. In addition, the DC electrode 23 does not configure a closed loop, therefore the consumed power is extremely low.

Further, in the dielectric 503 of the plasma generator 501, at the inner circumferential surfaces of the through holes 3h, recessed parts 503r are formed between the first electrode 509 and the second electrode 11. The recessed parts 503r are formed by the through holes 7h in the insulation layer 7 (7C) of part of the plurality of insulation layers 7 having a diameter larger than those of the through holes 7 in the other insulation layers 7.

When voltage is applied to the first electrode 509 and second electrode 11, the electric fields concentrate at the recessed parts 503r. Accordingly, the intensities of the electric fields in the through holes 3h easily exceed the discharge start field intensity. As a result, it becomes possible to generate plasma even at a relatively low voltage, therefore the consumed power can be kept down.

The present invention is not limited to the above embodiments and may be executed in various ways.

The first to fifth embodiments may be suitably combined. For example, the first electrode in the first embodiment may be combined with the second electrode in the second to fourth embodiments, and the second electrode in the first embodiment may be combined with the first electrode in the second to fourth embodiments. The first electrode in the second embodiment (FIG. 4) may be combined with the second electrode in the third or fourth embodiment, and the second electrode in the second embodiment may be combined with the first electrode in the third to fifth embodiments. The first electrode in the third embodiment (FIG. 5) may be combined with the second electrode in the fourth embodiment, and the second electrode in the third embodiment may be combined with the first electrode in the fourth or fifth embodiment. The second electrode in the fourth embodiment (FIG. 6) may be combined with the first electrode in the fifth embodiment. The DC electrode and/or recessed parts in the fifth embodiment (FIG. 7) may be provided in the first to fourth embodiments or an embodiment which is obtained by suitably combining these.

The dielectric need only be formed with through holes and is not limited to one which has the shape of a disk. For example, the dielectric may be one in a rectangular flat plate shaped one or box shaped one or columnar shaped one. Further, a plurality of through holes need not be provided in the dielectric. The number may be one.

The through holes may change in diameter at different positions in the penetrating direction. In this case, the change of the diameter may be continuous or intermittent (step parts may be formed on the inner circumferential surfaces of the through holes). In the case where steps parts are formed on the inner circumferential surfaces of the through holes, the layer-shaped part of the electrode may be exposed at those step parts.

The dielectric is not limited to one configured by a ceramic multilayer board. For example, the dielectric may be one formed from a single ceramic green sheet or may be one formed by filling an insulating material in a mold.

The first electrode and second electrode need only be shaped to surround the through holes when viewed in the penetrating direction of the through holes and are not limited to those exemplified in the embodiments. For example, the second electrode may be one configured by only a via conductor (not including a layer-shaped part).

The first electrode need not be exposed in the through holes. For example, the edge parts of the first electrode which is comprised of the layer-shaped part at the through hole sides (see the first embodiment) or the tubular parts of the first electrode (see the second embodiment) may be coated by a ceramic. Even in this case, due to the second electrode being further away from the inner circumferential surfaces of the through holes to the outer circumferential sides than the first electrode (by being buried deeper than the first electrode), a dielectric barrier discharge is caused from the first electrode to the second electrode side, thus ion wind from the first electrode side to the second electrode side can be generated.

The second electrode as a whole does not have to be positioned further toward one side in the penetrating direction of the through hole relative to the first electrode. That is, when viewed in a direction perpendicular to the penetrating direction, a portion on upstream side of the second electrode may overlap the all or portion on the downstream side of the first electrode as well. For example, in the third embodiment (FIG. 5), a portion on the downstream side of the tubular part 17 and a portion on the upstream side of the via conductor 19 may overlap in positions in the penetrating direction.

The application of the plasma generator and plasma generating device in the present invention is not limited to reforming a gas. For example, as exemplified in the embodiments, in the case where a plurality of through holes are distributed in the dielectric, the area of the surface on which the plasma is generated is large relative to the volume of the dielectric, and the plasma is sent out from the through holes by the ion wind, therefore the plasma generator in the present invention can form a plasma supply device which is small-sized and is capable of efficiently supplying plasma in processing of a semiconductor wafer etc.

### REFERENCE SIGNS LIST

1 . . . plasma generator, 3 . . . dielectric, 3h . . . through hole, 9 . . . first electrode, and 11 . . . second electrode (downstream region).

1. A plasma generator comprising:
a dielectric with a through hole,
a first electrode which is provided in the dielectric and surrounds the through hole when viewed in the penetrating direction of the through hole, and
a second electrode which is provided in the dielectric and includes a downstream region which is positioned further toward one side of the penetrating direction than the first electrode, the downstream region surrounding the through hole and being further away from the inner circumferential surface of the through hole toward the outer circumferential side than the first electrode when viewed in the penetrating direction.

2. The plasma generator as set forth in claim 1, wherein the downstream region includes a layer-shaped part formed in the shape of a flat plate which faces the penetrating direction and having an opening formed at position corresponding to the through hole.

3. The plasma generator as set forth in claim 2, wherein the downstream region includes a plurality of the layer-shaped parts which are arranged in the penetrating direction.

4. The plasma generator as set forth in claim 1, wherein the downstream region further includes a ring-shaped portion which extends in the penetrating direction and surrounds the through hole.

5. The plasma generator as set forth in claim 4, wherein the ring-shaped portion includes a plurality of via conductors which penetrate through at least a portion of the dielectric in the penetrating direction and are arranged so as to surround the through hole.

6. The plasma generator as set forth in claim 1, wherein
the downstream region has
a first portion and
a second portion which is positioned further toward the one side of the penetrating direction than the first portion and is closer to the inner circumferential surface of the through hole than the first portion.

7. The plasma generator as set forth in claim 1, wherein the first electrode includes a layer-shaped part which is formed in the shape of a flat plate which faces the penetrating direction and has an opening at position corresponding to the through hole.

8. The plasma generator as set forth in claim 1, wherein the first electrode includes a tubular part which is provided on the inner circumferential surface of the through hole and surrounds the through hole.

9. The plasma generator as set forth in claim 1, further comprising
an electric field forming member for forming an electric field further toward to the one side of the penetrating direction than the second electrode, the orientation of the electric field being the above penetrating direction.

10. The plasma generator as set forth in claim 9, wherein the electric field forming member is a DC electrode which is positioned further toward the one side of the penetrating direction than the second electrode and to which a DC voltage is applied in a state where a closed loop is not formed.

11. A plasma generating device comprising:
a dielectric with a through hole,
a first electrode which is provided in the dielectric and surrounds the through hole when viewed in the penetrating direction of the through hole,
a second electrode which is provided in the dielectric and includes a downstream region positioned further toward one side of the penetrating direction than the first electrode, the downstream region surrounding the through hole and being further away from the inner circumferential surface of the through hole toward the outer circumferential side than the first electrode when viewed in the penetrating direction, and
a power source for applying voltage across the first electrode and the second electrode.

12. The plasma generator as set forth in claim 2, wherein the downstream region further includes a ring-shaped portion which extends in the penetrating direction and surrounds the through hole.

13. The plasma generator as set forth in claim 3, wherein the downstream region further includes a ring-shaped portion which extends in the penetrating direction and surrounds the through hole.

14. The plasma generator as set forth in claim 4, wherein
the downstream region has
a first portion and
a second portion which is positioned further toward the one side of the penetrating direction than the first portion and is closer to the inner circumferential surface of the through hole than the first portion.

15. The plasma generator as set forth in claim 5, wherein
the downstream region has
a first portion and
a second portion which is positioned further toward the one side of the penetrating direction than the first portion and is closer to the inner circumferential surface of the through hole than the first portion.

16. The plasma generator as set forth in claim 4, wherein the first electrode includes a layer-shaped part which is formed in the shape of a flat plate which faces the penetrating direction and has an opening at position corresponding to the through hole.

17. The plasma generator as set forth in claim 5, wherein the first electrode includes a layer-shaped part which is formed in the shape of a flat plate which faces the penetrating direction and has an opening at position corresponding to the through hole.

18. The plasma generator as set forth in claim 2, wherein the first electrode includes a tubular part which is provided on the inner circumferential surface of the through hole and surrounds the through hole.

19. The plasma generator as set forth in claim 3, wherein the first electrode includes a tubular part which is provided on the inner circumferential surface of the through hole and surrounds the through hole.
